(19) United States
(12) Patent Application Publication
(10) Pub. No.: US 2025/0206952 A1
(43) Pub. Date: Jun. 26, 2025

(54) COMPOSITIONS, METHODS AND USES

(71) Applicant: INNOSPEC LIMITED, Cheshire (GB)

(72) Inventor: Richard Paul DALE, Ellesmere Port (GB)

(21) Appl. No.: 18/849,918

(22) PCT Filed: Mar. 23, 2023
(86) PCT No.: PCT/GB2023/050736

§ 371 Date: Sep. 23, 2024

(30) Foreign Application Priority Data
Mar. 23, 2022 (GB) 2204084.4

(51) Int. Cl. C08L 91/00; C08J 3/22; C08K 5/13

(52) U.S. Cl. CPC C08L 91/00; C08J 3/226; C08K 5/13; C08J 2391/00; C08J 2461/10; C08J 2471/02; C08L 2201/08; C08L 2205/035; C08L 2207/32; C08L 2310/00

(57) ABSTRACT

A composition including a pyrolysis oil and, as an additive, one or more of: (a) an antioxidant; and (b) a stabilising additive selected from (i) alkoxylated amine compounds; (ii) aldehyde-alkylphenol copolymers; (iii) a quaternary ammonium salt, and mixtures thereof. A method and use for improving the stability of a composition including a pyrolysis oil by addition to the composition one or more of said additives is also provided.

The present invention relates to pyrolysis oils and methods and uses relating thereto. In particular the invention relates to additives for improving the stability of compositions comprising plastic pyrolysis oils.

Pyrolysis oils are the fluids generated from the pyrolysis of waste, for example plastic waste, biomass for example agricultural waste, forestry waste, waste cooking oils and algae waste. Examples of waste plastic which may be pyrolysed to produce plastic pyrolysis oils include polyethylene, polypropylene, polystyrene, polyethylene terephthalates (PET) and rubber (eg from tyres). The organic liquid produced by pyrolysis of plastics and other waste materials has a very dark colour, an unpleasant odour and is unstable. However there is a strong desire to find a use for such oils to avoid such waste being sent to landfill or polluting oceans.

Pyrolysis oils can be used as a feedstock for chemical processing, for example in the production of polymers such as polyethylene. They may also be used in fuel oils. The use of pyrolysis oils to produce polymers represents a sustainable alternative to the use of crude oil feedstocks.

The utility of pyrolysis oils is limited due to their poor stability, particularly on cooling for example during transport or storage. This may be due to oxidation of oxygen or nitrogen containing species present in the oil. However it is also believed that sedimentation of particulates from the bulk oil is also a problem.

Pyrolysis oils can be optionally hydrotreated or cracked before subsequent use. Such processes may increase their stability. Alternatively they may be treated with chemical additives to improve their stability.

The present inventors have found that certain compounds are effective at reducing sedimentation from and/or improving the stability of compositions comprising pyrolysis oils.

According to a first aspect of the present invention there is provided a composition comprising a pyrolysis oil and, as an additive, one or more of:
(a) an antioxidant; and
(b) a stabilising additive selected from (i) alkoxylated amine compounds; (ii) aldehyde-alkylphenol copolymers; and mixtures thereof.

In some aspects, the stabilising additive (b) may be (iii) a quaternary ammonium salt. Therefore according to a further aspect of the present invention, there is provided a composition comprising a pyrolysis oil and, as an additive, one or more of:
(a) an antioxidant; and
(b) a stabilising additive selected from (i) alkoxylated amine compounds; (ii) aldehyde-alkylphenol copolymers; (iii) quaternary ammonium salts; and mixtures thereof.

The first aspect of the present invention relates to a composition comprising a pyrolysis oil. The pyrolysis oil may be obtained from the pyrolysis of any type of waste. The components of the oil and the properties thereof will depend on the types of waste that was pyrolysed and the pyrolysis conditions. For example the pyrolysis oil may be obtained from the pyrolysis of plastic waste, agricultural waste, forestry waste, waste cooking oils and algae waste.

Preferably the pyrolysis oil comprises a plastic pyrolysis oil. The plastic pyrolysis oil may be obtained from the pyrolysis of any type of plastic. For example, the pyrolysis oil may be obtained from the pyrolysis of used tyres.

Preferred plastic pyrolysis oils are obtained from the pyrolysis of one or polymers selected from polyethylene, polypropylene, PET, rubber and mixtures thereof.

Preferred plastic pyrolysis oils are obtained from the more pyrolysis of one or more polymers selected from polyethylene, polypropylene, PET, rubber, used tyres and mixtures thereof.

In some embodiments the pyrolysis oil in the composition of the first aspect may be a hydrotreated pyrolysis oil.

In some embodiments the pyrolysis oil in the composition of the first aspect have been treated using a cracking process.

In preferred embodiments the composition of the first aspect comprises a pyrolysis oil directly obtained from a pyrolysis plant without purification or further treatment.

In some embodiments the composition of the first aspect may comprise a blended fuel oil comprising a plastic pyrolysis oil and one or more fuel oils from hydrocarbon and/or renewable sources.

In some embodiments the composition of the first aspect comprises a blended fuel oil comprising a plastic pyrolysis oil and a middle distillate fuel oil.

The middle distillate fuel oil may comprise a petroleum-based fuel oil, especially a middle distillate fuel oil. Such distillate fuel oils generally boil within the range of from 110° C. to 500° C., e.g. 150° C. to 400° C. The middle distillate fuel oil may comprise atmospheric distillate or vacuum distillate, cracked gas oil, or a blend in any proportion of straight run and refinery streams such as thermally and/or catalytically cracked and hydro-cracked distillates.

The middle distillate fuel oil may comprise non-renewable Fischer-Tropsch fuels such as those described as GTL (gas-to-liquid) fuels, CTL (coal-to-liquid) fuels and OTL (oil sands-to-liquid).

The middle distillate fuel oil may comprise a renewable fuel such as a biofuel composition or biodiesel composition.

The middle distillate fuel oil may comprise 1st generation biodiesel. First generation biodiesel contains esters of, for example, vegetable oils, animal fats and used cooking fats. This form of biodiesel may be obtained by transesterification of oils, for example rapeseed oil, soybean oil, safflower oil, palm oil, palm kernel oil, corn oil, peanut oil, cotton seed oil, tallow, coconut oil, physic nut oil (Jatropha), sunflower seed oil, used cooking oils, hydrogenated vegetable oils or any mixture thereof, with an alcohol, usually a monoalcohol, in the presence of a catalyst.

The middle distillate fuel oil may comprise second generation biodiesel. Second generation biodiesel is derived from renewable resources such as vegetable oils and animal fats and processed, often in the refinery, often using hydroprocessing such as the H-Bio process developed by Petrobras. Second generation biodiesel may be similar in properties and quality to petroleum based fuel oil streams, for example renewable diesel produced from vegetable oils, animal fats etc. and marketed by ConocoPhillips as Renewable Diesel and by Neste as NExBTL.

The middle distillate fuel oil used in the present invention may comprise third generation biodiesel. Third generation biodiesel utilises gasification and Fischer-Tropsch technology including those described as BTL (biomass-to-liquid) fuels. Third generation biodiesel does not differ widely from some second generation biodiesel, but aims to exploit the whole plant (biomass) and thereby widens the feedstock base.

The middle distillate fuel oil may contain blends of any or all of the above diesel fuel oils.

In some embodiments the middle distillate fuel oil may be a blended diesel fuel comprising bio-diesel. In such blends the bio-diesel may be present in an amount of, for example up to 0.5%, up to 1%, up to 2%, up to 3%, up to 4%, up to 5%, up to 10%, up to 20%, up to 30%, up to 40%, up to 50%, up to 60%, up to 70%, up to 80%, up to 90%, up to 95% or up to 99%.

In some embodiments the middle distillate fuel oil may comprise a secondary fuel, for example ethanol. Preferably however the diesel fuel composition does not contain ethanol.

The middle distillate fuel oil may contain a relatively high sulphur content, for example greater than 0.05% by weight, such as 0.1% or 0.2%.

However in preferred embodiments the middle distillate fuel oil has a sulphur content of at most 0.05% by weight, more preferably of at most 0.035% by weight, especially of at most 0.015%. Fuels with even lower levels of sulphur are also suitable such as, fuels with less than 50 ppm sulphur by weight, preferably less than 20 ppm, for example 10 ppm or less.

Various metal species may be present in the middle distillate fuel oil. This may be due to contamination of the fuel during manufacture, storage, transport or use or due to contamination of fuel additives. Metal species may also be added to fuels deliberately. For example transition metals are sometimes added as fuel borne catalysts, for example to improve the performance of diesel particulate filters.

In preferred embodiments the middle distillate fuel oil used in the present invention comprise sodium and/or calcium. Preferably they comprise sodium. The sodium and/or calcium is typically present in a total amount of from 0.01 to 50 ppm, preferably from 0.05 to 5 ppm preferably 0.1 to 2 ppm, such as 0.1 to 1 ppm.

Other metal-containing species may also be present as a contaminant, for example through the corrosion of metal and metal oxide surfaces by acidic species present in the fuel or from lubricating oil. In use, fuels such as diesel fuels routinely come into contact with metal surfaces for example, in vehicle fueling systems, fuel tanks, fuel transportation means etc. Typically, metal-containing contamination may comprise transition metals such as zinc, iron and copper; other group I or group II metals and other metals such as lead.

In addition to metal-containing contamination which may be present in middle distillate fuel oils there are circumstances where metal-containing species may deliberately be added to the fuel. For example, as is known in the art, metal-containing fuel-borne catalyst species may be added to aid with the regeneration of particulate traps.

Metal-containing contamination, depending on its source, may be in the form of insoluble particulates or soluble compounds or complexes. Metal-containing fuel-borne catalysts are often soluble compounds or complexes or colloidal species.

In some embodiments, the middle distillate fuel oil may comprise metal-containing species comprising a fuel-borne catalyst. Preferably, the fuel borne catalyst comprises one or more metals selected from iron, cerium, platinum, manganese, Group I and Group II metals e.g., calcium and strontium. Most preferably the fuel borne catalyst comprises a metal selected from iron and cerium.

In some embodiments, the middle distillate fuel oil may comprise metal-containing species comprising zinc. Zinc may be present in an amount of from 0.01 to 50 ppm, preferably from 0.05 to 5 ppm, more preferably 0.1 to 1.5 ppm.

The composition of the first aspect comprises one or more of (a) an antioxidant and (b) a stabilising additive.

In some embodiments the composition of the first aspect comprises (a) an antioxidant. Mixtures of two or more antioxidants may be present.

In some embodiments the composition of the first aspect comprises (b) a stabilising additive.

In some embodiments the composition of the first aspect comprises (a) an antioxidant and (b) a stabilising additive.

The stabilising additive may comprise (i) alkoxylated amine compounds, (ii) aldehyde-alkylphenol copolymers, or mixtures thereof.

In some embodiments the composition of the first aspect comprises (b) a stabilising additive comprising (i) alkoxylated amine compounds.

In some embodiments the composition of the first aspect comprises (b) a stabilising additive comprising (ii) aldehyde-alkylphenol copolymers.

In some preferred embodiments the composition of the first aspect comprises (b) a stabilising additive comprising (i) alkoxylated amine compounds and (ii) aldehyde-alkylphenol copolymers.

In some embodiments the composition of the first aspect comprises (a) an antioxidant and (b) a stabilising additive comprising (i) alkoxylated amine compounds.

In some embodiments the composition of the first aspect comprises (a) an antioxidant and (b) a stabilising additive comprising (ii) aldehyde-alkylphenol copolymers.

In some preferred embodiments the composition of the first aspect comprises (a) an antioxidant and (b) a stabilising additive comprising (i) alkoxylated amine compounds and (ii) aldehyde-alkylphenol copolymers.

In some embodiments the composition of the first aspect comprises (b) a stabilising additive comprising one or more of (iii) quaternary ammonium salts.

In some preferred embodiments the composition of the first aspect comprises (b) a stabilising additive comprising (i) alkoxylated amine compounds and one or more of (iii) quaternary ammonium salts.

In some preferred embodiments the composition of the first aspect comprises (b) a stabilising additive comprising (ii) aldehyde-alkylphenol copolymers and one or more of (iii) quaternary ammonium salts.

In some embodiments the composition of the first aspect comprises (a) an antioxidant and (b) a stabilising additive comprising one or more of (iii) quaternary ammonium salts.

In some preferred embodiments the composition of the first aspect comprises (a) an antioxidant and (b) a stabilising additive comprising (i) alkoxylated amine compounds and one or more of (iii) quaternary ammonium salts.

In some preferred embodiments the composition of the first aspect comprises (a) an antioxidant and (b) a stabilising additive comprising (ii) aldehyde-alkylphenol copolymers and one or more of (iii) quaternary ammonium salts.

In some preferred embodiments the composition of the first aspect comprises (a) an antioxidant and (b) a stabilising additive comprising (i) alkoxylated amine compounds, (ii) aldehyde-alkylphenol copolymers and one or more of (iii) quaternary ammonium salts.

Suitable antioxidants for us herein include phenolic antioxidants, and amino based antioxidants.

Suitable amino based antioxidants include aromatic amines, hindered amines, N-oxides, polyalkylene polyamines; and polyisobutenyl substituted succinimides.

Suitable aromatic amines include diaminobenzene and alkylated diamino benzenes, especially dialkylated and trialkylated diaminobenzenes, for example p-phenylenediamine, 3,5-diethyltoluene-2,4-diamine; 3,5-diethyltoluene-2,2-diamine; 2,4,6-triethylbenzene-2,6-diamine alkylated diphenyl amines; diphenylamines and alkylated diphenylamines, for example N,N-diphenyl-1,4-phenylenediamines; and naphthylamines, for example N-phenyl-1-napthylamine and N-phenyl-2-naphthylamine.

Suitable hindered amines include secondary and tertiary aliphatic amines, for example dimethyl cyclohexylamine and diethylhydroxylamine.

Suitable N-oxides include TEMPO and derivatives thereof.

Polyisobutenyl substituted succinimides are known to those skilled in the art and their use as an antioxidant is described for example in WO2009/016400.

Preferably the composition of the first aspect comprises a phenolic antioxidant.

In some embodiments the composition of the first aspect comprises an amino based and a phenolic antioxidant.

Any suitable phenolic antioxidant may be used. Suitable antioxidants will be known to the person skilled in the art.

By phenolic antioxidant compound we mean to include any compound which contains a phenol moiety i.e., a benzene ring which is substituted with a hydroxyl group. This may be a very simple compound, for example a benzene diol, alkyl substituted phenol or a benzene triol. Alternatively the phenolic antioxidant may be part of a more complex molecule. It may include two phenol moieties, for example, see the compounds disclosed in US 2006/0219979.

Suitable phenolic antioxidant compounds for use in the present invention include those of formula (I):

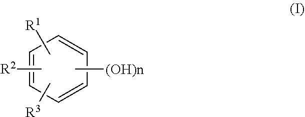

wherein R¹ is selected from an optionally substituted alkyl or alkenyl group, an aryl group, an aralkyl group; an ester, a carboxylic acid, an aldehyde, a ketone, an ether, an alcohol, an amine or an amide; R² and R³ are independently selected from hydrogen, an optionally substituted alkyl or alkenyl group, an aryl group, an ester group, a ketone, an aldehyde, a carboxylic acid, an ether, an alcohol, an amine or an amide; and n is an integer from 1 to 5.

Preferably R¹ is an alkyl group, preferably having 1 to 9 carbon atoms, and may be straight chained or branched. Preferably R¹ is selected from methyl, ethyl, isopropyl, and tertiary butyl. R¹ and R² may together form a cyclic substituent, either alkyl or aryl. R² and R³ are preferably hydrogen or an alkyl group having 1 to 9 carbon atoms. Preferably R² and R³ are independently selected from hydrogen, methyl, ethyl, tertiary butyl and isopropyl. Preferably n is 1, 2 or 3.

Preferred phenolic antioxidant compounds for use in the present invention are substituted benzene compounds having 1 or more hydroxy substituents. Examples include tertiarybutylhydroquinone (TBHQ or MTBHQ), 2,5-di-tertiarybutylhydroquinone (DTBHQ), pyrogallol, pyrocatechol 2,6-di-tert-butyl-4-methylphenol (BHT), 2,6-ditertiary-butyl-phenol, propylgallate and tertiarybutylcatechol.

One especially preferred phenolic antioxidant for use herein is 2,6-ditertiary-butyl-phenol. However as the skilled person will appreciate commercial sources of this compound often comprise mixtures including tertiary and tritertiary-butyl-phenols.

In some embodiments, the antioxidant is the reaction product of a carboxylic acid-derived acylating agent and an amine. These compounds may also be referred to herein in general as acylated nitrogen-containing compounds. Such additives may be additionally or alternatively defined as stabilising additives. Therefore the reaction product of a carboxylic acid-derived acylating agent and an amine as defined herein may provide additive type (a) an antioxidant or additive type (b) a stabilising additive, in the composition comprising a pyrolysis oil of the first aspect.

Therefore, in a further aspect, the present invention may provide a composition comprising a pyrolysis oil and, as an additive, one or more of:
(a) an antioxidant; and
(b) a stabilising additive selected from (i) alkoxylated amine compounds; (ii) aldehyde-alkylphenol copolymers; (iii) quaternary ammonium salts; (iv) the reaction product of a carboxylic acid-derived acylating agent and an amine as defined herein; and mixtures thereof.

Suitable acylated nitrogen-containing compounds may be made by reacting a carboxylic acid acylating agent with an amine and are known to those skilled in the art. Suitable carboxylic acid acylating agents are hydrocarbyl substituted acylating agents.

As used herein, the term “hydrocarbyl substituent” or “hydrocarbyl group” is used in its ordinary sense, which is well-known to those skilled in the art. Specifically, it refers to a group having a carbon atom directly attached to the remainder of the molecule and having predominantly hydrocarbon character. Examples of hydrocarbyl groups include:
(i) hydrocarbon groups, that is, aliphatic (which may be saturated or unsaturated, linear or branched, e.g., alkyl or alkenyl), alicyclic (e.g., cycloalkyl, cycloalkenyl) substituents, and aromatic (including aliphatic- and alicyclic-substituted aromatic) substituents, as well as cyclic substituents wherein the ring is completed through another portion of the molecule (e.g., two substituents together form a ring);
(ii) substituted hydrocarbon groups, that is, substituents containing non-hydrocarbon groups which, in the context of this invention, do not alter the predominantly hydrocarbon nature of the substituent (e.g., halo (e.g. chloro, fluoro or bromo), hydroxy, alkoxy (e.g. C₁ to C₄ alkoxy), keto, acyl, cyano, mercapto, amino, amido, nitro, nitroso, sulfoxy, nitryl and carboxy);
(iii) hetero substituents, that is, substituents which, while having a predominantly hydrocarbon character, in the context of this invention, contain atoms other than carbon in a ring or chain otherwise composed of carbon atoms. Heteroatoms include sulphur, oxygen, nitrogen, and encompass substituents as pyridyl, furyl, thienyl and imidazolyl. In general, no more than two, preferably no more than one, non-hydrocarbon substituent will be present for every ten carbon atoms in the hydrocarbyl group; typically, there will be no non-hydrocarbon substituents in the hydrocarbyl group.

Preferred hydrocarbyl substituted acylating agents are polyisobutenyl succinic anhydrides. These compounds are commonly referred to as “PIBSAs” and are known to the person skilled in the art.

In such embodiments, the antioxidant is suitably a polyisobutenyl substituted succinimide.

Conventional polyisobutenes and so-called “highly-reactive” polyisobutenes are suitable for use in the invention. Highly reactive polyisobutenes in this context are defined as polyisobutenes wherein at least 50%, preferably 70% or more, of the terminal olefinic double bonds are of the vinylidene type as described in EP0565285. Particularly preferred polyisobutenes are those having more than 80 mol % and up to 100 mol % of terminal vinylidene groups such as those described in U.S. Pat. No. 7,291,758. Preferred polyisobutenes have preferred molecular weight (Mn) ranges as described above for hydrocarbyl substituents generally.

Especially preferred PIBSAs are those having a PIB molecular weight (Mn) of from 300 to 2800, preferably from 450 to 2300, more preferably from 500 to 1300.

In preferred embodiments the reaction product of the carboxylic acid derived acylating agent and an amine includes at least one primary or secondary amine group.

A preferred acylated nitrogen-containing compound for use herein is prepared by reacting a poly(isobutene)-substituted succinic acid-derived acylating agent (e.g., anhydride, acid, ester, etc.) wherein the poly(isobutene) substituent has a number average molecular weight (Mn) of between 170 to 2800 with a mixture of ethylene polyamines having 2 to about 9 amino nitrogen atoms, preferably about 2 to about 8 nitrogen atoms, per ethylene polyamine and about 1 to about 8 ethylene groups. These acylated nitrogen compounds are suitably formed by the reaction of a molar ratio of acylating agent:amino compound of from 10:1 to 1:10, preferably from 5:1 to 1:5, more preferably from 2:1 to 1:2 and most preferably from 2:1 to 1:1. In especially preferred embodiments, the acylated nitrogen compounds are formed by the reaction of acylating agent to amino compound in a molar ratio of from 1.8:1 to 1:1.2, preferably from 1.6:1 to 1:1.2, more preferably from 1.4:1 to 1:1.1 and most preferably from 1.2:1 to 1:1. Acylated amino compounds of this type and their preparation are well known to those skilled in the art and are described in for example EP0565285 and U.S. Pat. No. 5,925,151.

In some preferred embodiments the composition comprises a compound of the type formed by the reaction of a polyisobutene-substituted succinic acid-derived acylating agent and a polyethylene polyamine. Suitable compounds are, for example, described in WO2009/040583.

In a preferred embodiment the reaction product of a carboxylic acid-derived acylating agent and an amine (b) comprises the reaction product of a polyisobutene-substituted succinic acid or succinic anhydride and a polyethylene polyamine selected from ethylenediamine, diethylenetriamine, triethylenetetramine, tetraethylenepentamine, pentaethylenehexamine, hexaethylene-heptamine and mixtures and isomers thereof; wherein polyisobutene substituent has a number average molecular weight of between 500 and 2000, preferably between 600 and 1000.

The composition of the first aspect may comprise a stabilising additive selected from (i) alkoxylated amine compounds, (ii) aldehyde-alkylphenol copolymers, or mixtures thereof.

By stabilising additive we mean to refer to a component which improves the stability of the pyrolysis oil composition, for example the storage or oxidation stability thereof, or which aids the dispersion of solids, waxes or high molecular weight gums within the pyrolysis oil. Suitable stabilising additives may be known in the art as dispersants.

The composition may include any alkoxylated amine compound. By this we mean to include any compound including an amine functional group which has been reacted with at least one alkylene oxide moiety.

In preferred embodiments the alkoxylated amine compounds include more than one alkylene oxide residue.

Suitably alkylene oxide residues include ethylene oxide residues, propylene oxide residues, butylene oxide residues and mixtures thereof.

Preferably the alkoxylated amine compounds include ethylene oxide residues, propylene oxide residues, or mixtures thereof.

Preferably the alkoxylated amine compounds are alkoxylated amines, alkoxylated diamines or alkoxylated polyamines.

Some preferred alkoxylated amine compounds for use herein have the formula A-(RO)ₙ—H wherein A is the residue of an amine and RO is an alkylene oxide residue and n is at least one.

R is preferably an ethylene, propylene or butylene group. R may be an n-propylene or n-butylene group or an isopropylene or isobutylene group. For example R may be —CH₂CH₂—, —CH₂CH(CH₃)—, —CH₂C(CH₃)₂, —CH(CH₃)CH(CH₃)— or —CH₂CH(CH₂CH₃)—.

R may comprise a mixture of isomers. For example when R is propylene, the polyhydric alcohol may include moieties —CH₂CH(CH₃)— and —CH(CH₃)CH₂— in any order within the chain.

Each R may be the same of different. R may comprise a mixture of different groups for example ethylene, propylene or butylene units. Block copolymer units are preferred in such embodiments.

Preferably R is ethylene and/or propylene. More preferably R is —CH₂CH₂— or —CH(CH₃)CH₂—.

In some preferred embodiments the alkoxylated amine compounds (i) comprise a mixture of ethylene oxide residues and propylene oxide residues.

n is at least 1. Preferably n is from 5 to 1000, preferably from 5 to 500, more preferably from 10 to 400, more preferably from 15 to 300, preferably from 20 to 250, suitably from 30 to 200, preferably from 50 to 150.

A is the residue of an amine. Suitably A is the residue of an amino or polyamino compound having at least one NH group. Suitable amino compounds include primary or secondary monoamines having hydrocarbon substituents of 1 to 30 carbon atoms or hydroxyl-substituted hydrocarbon substituents of 1 to about 30 carbon atoms.

Preferably A is the residue of a polyamine.

Polyamines may be selected from any compound including two or more amine groups. Preferably the polyamine is a (poly)alkylene polyamine (by which is meant an alkylene polyamine or a polyalkylene polyamine; including in each case a diamine, within the meaning of “polyamine”). Preferably the polyamine is a (poly)alkylene polyamine in which the alkylene component has 1 to 6, preferably 1 to 4, most preferably 2 to 3 carbon atoms. Most preferably the polyamine is a (poly) ethylene polyamine (that is, an ethylene polyamine or a polyethylene polyamine).

Preferably the polyamine has 2 to 15 nitrogen atoms, preferably 2 to 10 nitrogen atoms, more preferably 2 to 8 nitrogen atoms.

The polyamine may, for example, be selected from ethylenediamine, diethylenetriamine, triethylenetetramine, tetraethylenepentamine, pentaethylene-hexamine, hexaethyleneheptamine, heptaethyleneoctamine, propane-1,2-diamine, 2(2-amino-ethylamino)ethanol, N′,N′-bis(2-aminoethyl) ethylenediamine (N(CH₂CH₂NH₂)₃), diphenyl 4, 4′-diamine, diamino naphthalene, phenylene diamine, xylene diamine, 1,2-diaminopropane and 1,3-diaminopropane, 1,4-diaminobutane, 1,5-diamino pentane and 1,6-diamino hexane.

Most preferably A is the residue of ethylenediamine.

In some preferred embodiments the alkoxylated amine compounds (i) comprise compounds of formula (II):

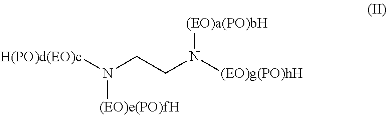

wherein EO represents an ethylene oxide residue, PO represents a propylene oxide residue and at least one of a, b, c, d, e, f, g and h is not 0. The compounds of formula (II) may be prepared by reaction of the ethylene diamine with the ethylene oxide and propylene oxide (when both present) in any combination thereof and in any order, i.e. so as to provide compounds of formula (II) in which the ethylene oxide and propylene oxide residues may be present in any combination and in any order as bonded to the nitrogen of the amine group.

Preferably each of a, b, c, d, e, f, g and h is at least one. Preferably the sum of a, b, c, d, e, f, g and h is from 10 to 500, preferably from 20 to 250, more preferably from 40 to 200.

The skilled person will appreciate that polymeric compounds of formula (II) are usually in the form of mixtures.

Some suitable alkoxylated amine compounds for use herein are described in U.S. Pat. No. 6,838,422.

In some embodiments the composition of the first aspect may comprise aldehyde-alkylphenol copolymers.

Any suitable aldehyde-alkylphenol copolymer may be used and such compounds will be known to those skilled in the art.

Preferably the aldehyde used to prepare the aldehyde-alkylphenol copolymers is selected from formaldehyde or a reactive equivalent thereof, for example paraformaldehyde, C₂ to C₁₀ aldehydes and aromatic aldehydes, for example benzaldehyde.

Preferred aldehyde-alkylphenol copolymers are copolymers of formaldehyde and an alkyl phenol. Preferably the phenol is mono-substituted with an alkyl group, preferably at the para position. Preferred alkyl groups have 1 to 40 carbon atoms, preferably 2 to 36 carbon atoms, more preferably 4 to 30 carbon atoms, for example 6 to 24 carbon atoms.

In some embodiments the alkyl phenol is a polyisobutenyl (PIB) substituted phenol.

Polyisobutenyl (PIB) substituted phenols include a hydrocarbyl chain having the repeating unit:

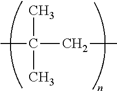

Poly(isobutenes) are prepared by the addition polymerisation of isobutene, (CH₃)₂C≡CH₂. Each molecule of the resulting polymer will include a single alkene moiety.

Conventional polyisobutenes and so-called “highly-reactive” polyisobutenes are suitable for use in preparing additive (ii) of the present invention. Highly reactive polyisobutenes in this context are defined as polyisobutenes wherein at least 50%, preferably 70% or more, of the terminal olefinic double bonds are of the vinylidene type as described in EP0565285. Particularly preferred polyisobutenes are those having more than 80 mol % and up to 100% of terminal vinylidene groups such as those described in EP1344785.

Methods of preparing polyalkylene substituted phenols, for example polyisobutene substituted phenols are known to the person skilled in the art, and include the methods described in EP831141.

The hydrocarbyl substituent of the PIB substituent preferably has an average molecular weight of 200 to 3000. Preferably it has a molecular weight of at least 225, suitably at least 250, preferably at least 275, suitably at least 300, for example at least 325 or at least 350. In some embodiments the hydrocarbyl substituent of component (c) has an average molecular weight of at least 375, preferably at least 400, suitably at least 475, for example at least 500.

In some embodiments the phenol may include a PIB substituent having an average molecular weight of up to 2800, preferably up to 2600, for example up to 2500 or up to 2400.

In some embodiments the phenol may include a PIB substituent having an average molecular weight of from 400 to 2500, for example from 450 to 2400, preferably from 500 to 1500, suitably from 550 to 1300.

In some embodiments the phenol may include a PIB substituent having an average molecular weight of from 200 to 600.

In some embodiments the phenol may include a PIB substituent having an average molecular weight of from 500 to 1000.

In some embodiments the phenol may include a PIB substituent having an average molecular weight of from 700 to 1300.

In some embodiments the phenol may include a PIB substituent having an average molecular weight of from 1000 to 2000.

In some embodiments the phenol may include a PIB substituent having an average molecular weight of from 1700 to 2600, for example 2000 to 2500.

In some preferred embodiment the aldehyde-alkylphenol copolymers have the structures (III) or (IV):

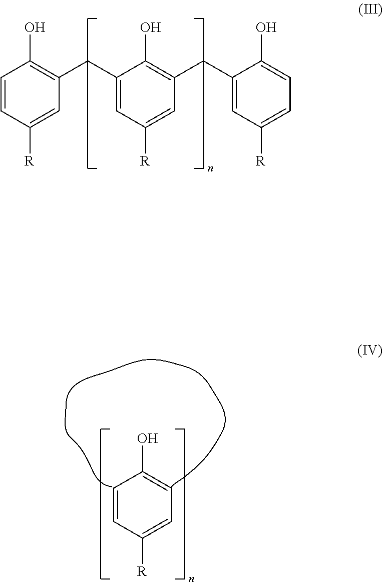

wherein R is hydrogen or an alkyl group and n is at least 1.

Preferably n is from 2 to 12, preferably from 5 to 9; and R is C3-C24-alkyl, preferably C4-C12-alkyl, in particular isononyl, isobutyl or amyl, C6-C12-aryl or -hydroxyaryl or C7-C12-aralkyl.

As the skilled person will appreciate the aldehyde-alkyl phenol copolymers may be prepared from mixtures of monomers, in particular compounds in which R comprises a mixture of alkyl groups. Further suitable aldehyde-alkyl phenol copolymers for use herein include compounds of formula (III) in which the terminal phenol groups are further functionalised, for example by reaction with a fatty acid or an amine and an aldehyde via a Mannich reaction. Compounds of this type are described, for example, in US2007/221539.

Preferably the aldehyde-alkylphenol copolymer has a number average molecular weight of from 500 to 20000, preferably from 1000 to 10000, more preferably from 1500 to 5000, for example from 2000 to 3500.

In some embodiments, the composition of the first aspect comprises, as an additive, one or more of (iii) quaternary ammonium salts.

Preferably the quaternary ammonium salt additive is the reaction product of a compound including a tertiary amine group and a quaternising agent.

Any suitable quaternising agent may be used. The quaternising agent may suitably be selected from esters and non-esters.

Suitable quaternising agents include esters of a carboxylic acid, dialkyl sulfates, benzyl halides, hydrocarbyl substituted carbonates, hydrocarbyl substituted epoxides optionally in combination with an acid, alkyl halides, alkyl sulfonates, sultones, hydrocarbyl substituted phosphates, hydrocarbyl substituted borates, alkyl nitrites, alkyl nitrates, hydroxides, N-oxides, chloroacetic acid or salts thereof, or mixtures thereof.

In some preferred embodiments, quaternising agents used to form the quaternary ammonium salt additives of the present invention are esters.

Preferred ester quaternising agents are compounds of formula (XI):

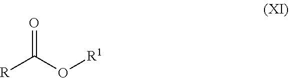

in which R is an optionally substituted alkyl, alkenyl, aryl or alkylaryl group and R¹ is a C1 to C22 alkyl, aryl or alkylaryl group. The compound of formula (XI) is suitably an ester of a carboxylic acid capable of reacting with a tertiary amine to form a quaternary ammonium salt.

Suitable quaternising agents include esters of carboxylic acids having a pKa of 3.5 or less.

The compound of formula (XI) is preferably an ester of a carboxylic acid selected from a substituted aromatic carboxylic acid, an α-hydroxycarboxylic acid and a polycarboxylic acid.

In some preferred embodiments the compound of formula (XI) is an ester of a substituted aromatic carboxylic acid and thus R is a substituted aryl group.

Preferably R is a substituted aryl group having 6 to 10 carbon atoms, preferably a phenyl or naphthyl group, most preferably a phenyl group. R is suitably substituted with one or more groups selected from carboalkoxy, nitro, cyano, hydroxy, SR⁵ or NR⁵R⁶. Each of R⁵ and R⁶ may be hydrogen or optionally substituted alkyl, alkenyl, aryl or carboalkoxy groups. Preferably each of R⁵ and R⁶ is hydrogen or an optionally substituted C1 to C22 alkyl group, preferably hydrogen or a C1 to C16 alkyl group, preferably hydrogen or a C1 to C10 alkyl group, more preferably hydrogen or a C1 to C4 alkyl group. Preferably R⁵ is hydrogen and R⁶ is hydrogen or a C1 to C4 alkyl group. Most preferably R⁵ and R⁶ are both hydrogen. Preferably R is an aryl group substituted with one or more groups selected from hydroxyl, carboalkoxy, nitro, cyano and NH₂.

R may be a poly-substituted aryl group, for example trihydroxyphenyl. In some embodiments R may be a hydrocarbyl substituted aryl group, for example an alkyl substituted aryl group. In some embodiments R may be an aryl group substituted with a hydroxy group and a hydrocarbyl group, such as an alkyl group, for example as described in EP2631283.

Preferably R is a mono-substituted aryl group. Preferably R is an ortho substituted aryl group. Suitably R is substituted with a group selected from OH, NH₂, NO₂ or COOMe. Preferably R is substituted with an OH or NH₂ group. Suitably R is a hydroxy substituted aryl group. Most preferably R is a 2-hydroxyphenyl group.

Preferably R¹ is an alkyl, aralkyl or alkaryl group. R¹ may be a C1 to C16 alkyl group, preferably a C1 to C10 alkyl group, suitably a C1 to C8 alkyl group. R¹ may be C7 to C16 aralkyl or alkaryl group, preferably a C7 to C10 aralkyl or alkaryl group. R¹ may be methyl, ethyl, propyl, butyl, pentyl, benzyl or an isomer thereof. Preferably R¹ is benzyl or methyl. Most preferably R¹ is methyl.

Especially preferred compounds of formula (XI) are lower alkyl esters of salicylic acid such as methyl salicylate, ethyl salicylate, n- and i-propyl salicylate, and butyl salicylate, preferably methyl salicylate.

In some embodiments the compound of formula (XI) is an ester of an α-hydroxycarboxylic acid.

In such embodiments the compound has the structure:

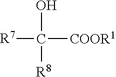

wherein R⁷ and R⁸ are the same or different and each is selected from hydrogen, alkyl, alkenyl, aralkyl or aryl. Compounds of this type suitable for use herein are described in EP1254889.

Examples of compounds of formula (XI) in which RCOO is the residue of an α-hydroxycarboxylic acid include methyl-, ethyl-, propyl-, butyl-, pentyl-, hexyl-, benzyl-, phenyl-, and allyl esters of 2-hydroxyisobutyric acid; methyl-, ethyl-, propyl-, butyl-, pentyl-, hexyl-, benzyl-, phenyl-, and allyl esters of 2-hydroxy-2-methylbutyric acid; methyl-, ethyl-, propyl-, butyl-, pentyl-, hexyl-, benzyl-, phenyl-, and allyl esters of 2-hydroxy-2-ethylbutyric acid; methyl-, ethyl-, propyl-, butyl-, pentyl-, hexyl-, benzyl-, phenyl-, and allyl esters of lactic acid; and methyl-, ethyl-, propyl-, butyl-, pentyl-, hexyl-, allyl-, benzyl-, and phenyl esters of glycolic acid. Of the above, a preferred compound is methyl 2-hydroxyisobutyrate.

In some embodiments the compound of formula (XI) is an ester of a polycarboxylic acid. In this definition we mean to include dicarboxylic acids and carboxylic acids having more than 2 acidic moieties. In such embodiments RCOO is preferably present in the form of an ester, that is the one or more further acid groups present in the group R are in esterified form. However embodiments in which not all acid groups are esterified are within the invention. Mixed esters of polycarboxylic acids may also be used. Preferred esters are C1 to C4 alkyl esters.

The ester quaternising agent may be selected from the diester of oxalic acid, the diester of phthalic acid, the diester of maleic acid, the diester of malonic acid or the diester of citric acid. One especially preferred compound of formula (XI) is dimethyl oxalate.

In preferred embodiments the compound of formula (XI) is an ester of a carboxylic acid having a pKa of less than 3.5. In such embodiments in which the compound includes more than one acid group, we mean to refer to the first dissociation constant.

The ester quaternising agent may be selected from an ester of a carboxylic acid selected from one or more of oxalic acid, phthalic acid, salicylic acid, maleic acid, malonic acid, citric acid, nitrobenzoic acid, aminobenzoic acid, 2,4,6-trihydroxybenzoic acid, succinic acid, glutaric acid, adipic acid, fumaric acid, acetylene dicarboxylic acid, glutaconic acid, muconic acid, citraconic acid, mesaconic acid, itaconic acid, tartronic acid, mesoxalic acid, tartaric acid, oxaloacetic acid, dioxosuccinic acid, alpha-hydroxyglutaric acid, diphenic acid and 2,6-naphthalenedicarboxylic acid.

The ester quaternising agent may be selected from an ester of a carboxylic acid selected from one or more of oxalic acid, phthalic acid, salicylic acid, maleic acid, malonic acid, citric acid, nitrobenzoic acid, aminobenzoic acid and 2,4,6-trihydroxybenzoic acid.

Preferred ester quaternising agents include dimethyl oxalate, methyl 2-nitrobenzoate and methyl salicylate.

In some preferred embodiments, quaternising agents used to form the quaternary ammonium salt additives of the present invention are esters selected from dimethyl oxalate, methyl 2-nitrobenzoate and methyl salicylate, preferably dimethyl oxalate and methyl salicylate.

Suitable non-ester quaternising agents include dialkyl sulfates, benzyl halides, hydrocarbyl substituted carbonates, hydrocarbyl substituted epoxides optionally in combination with an acid, alkyl halides, alkyl sulfonates, sultones, hydrocarbyl substituted phosphates, hydrocarbyl substituted borates, alkyl nitrites, alkyl nitrates, hydroxides, N-oxides, chloroacetic acid or salts thereof, or mixtures thereof.

Preferred non-ester quaternising agents include dialkyl sulfates, benzyl halides, hydrocarbyl substituted carbonates, hydrocarbyl substituted epoxides in combination with an acid, alkyl halides, alkyl sulfonates, sultones, hydrocarbyl substituted phosphates, hydrocarbyl substituted borates, N-oxides, chloroacetic acid or salts thereof, or mixtures thereof.

In some embodiments the quaternary ammonium salt may be prepared from, for example, an alkyl or benzyl halide (especially a chloride) and then subjected to an ion exchange reaction to provide a different anion as part of the quaternary ammonium salt. Such a method may be suitable to prepare quaternary ammonium hydroxides, alkoxides, nitrites or nitrates.

Suitable alkyl halides for use herein include chlorides, bromides and iodides.

Suitable benzyl halides include chlorides, bromides and iodides. The phenyl group may be optionally substituted, for example with one or more alkyl or alkenyl groups, especially when the chlorides are used. A preferred compound is benzyl bromide.

Suitable dialkyl sulfates for use herein as quaternising agents include those including alkyl groups having 1 to 10, preferably 1 to 4 carbons atoms in the alkyl chain. A preferred compound is dimethyl sulfate.

Suitable hydrocarbyl substituted carbonates may include two hydrocarbyl groups, which may be the same or different. Each hydrocarbyl group may contain from 1 to 50 carbon atoms, preferably from 1 to 20 carbon atoms, more preferably from 1 to 10 carbon atoms, suitably from 1 to 5 carbon atoms. Preferably the or each hydrocarbyl group is an alkyl group. Preferred compounds of this type include diethyl carbonate and dimethyl carbonate.

Suitable hydrocarbyl substituted epoxides have the formula:

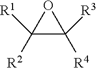

wherein each of R¹, R², R³ and R⁴ is independently hydrogen or a hydrocarbyl group having 1 to 50 carbon atoms. Examples of suitable epoxides include ethylene oxide, propylene oxide, butylene oxide, styrene oxide and stilbene oxide. The hydrocarbyl epoxides are used as quaternising agents in combination with an acid.

In some embodiments the compound including a tertiary amine group also includes an acid functional group. In these embodiments if an epoxide is used as the quaternising agent, a separate acid does not need to be added. However in other embodiments an acid, for example acetic acid, may be used.

Especially preferred epoxide quaternising agents are propylene oxide and styrene oxide, optionally in combination with an additional acid.

Suitable alkyl sulfonates include those having 1 to 20, preferably 1 to 10, more preferably 1 to 4 carbon atoms.

Suitable sultones include propane sultone and butane sultone.

Suitable hydrocarbyl substituted phosphates include monoalkyl phosphates, dialkyl phosphates, trialkyl phosphates and O,O-dialkyl dithiophospates. Preferred alkyl groups have 1 to 12 carbon atoms.

Suitable hydrocarbyl substituted borate groups include alkyl borates having 1 to 12 carbon atoms.

Preferred alkyl nitrites and alkyl nitrates have 1 to 12 carbon atoms.

Preferably the non-ester quaternising agent is selected from dialkyl sulfates, benzyl halides, hydrocarbyl substituted carbonates, hydrocarbyl substituted epoxides optionally in combination with an additional acid, chloroacetic acid or a salt thereof, and mixtures thereof.

Especially preferred non-ester quaternising agents for use herein are hydrocarbyl substituted epoxides in combination with an acid. These may include embodiments in which a separate acid is provided or embodiments in which the acid is provided by the tertiary amine compound that is being quaternised. Preferably the acid is provided by the tertiary amine molecule that is being quaternised.

Preferred quaternising agents for use herein include dimethyl oxalate, methyl 2-nitrobenzoate, methyl salicylate, chloroacetic acid or a salt thereof, and styrene oxide or propylene oxide optionally in combination with an additional acid.

In some embodiments mixtures of two or more quaternising agents may be used.

To form the quaternary ammonium salt additive the quaternising agent is reacted with a compound including a tertiary amine group.

Any suitable compound including a tertiary amine group may be used.

The compound including at least one tertiary amine group may be selected from:
(1) the reaction product of a hydrocarbyl-substituted acylating agent and a compound comprising at least one tertiary amine group and a primary amine, secondary amine or alcohol group;
(2) a Mannich reaction product comprising a tertiary amine group;
(3) a polyalkylene substituted amine having at least one tertiary amine group; and
(4) simple alkylamines and alkanolamines.

Examples of quaternary ammonium salt and methods for preparing the same are described in the following patents: US2008/0307698, US2008/0052985, US2008/0113890 and US2013/031827.

The preparation of some suitable quaternary ammonium salt additives in which the compound including at least one tertiary amine group of the type (1) is described in WO2006/135881, US2020/0024536 and WO2011/095819.

The preparation of quaternary ammonium salts in which the compound including at least one tertiary amine group of the type (2) is described in US 2008/0052985.

The preparation of quaternary ammonium salt additives in which the compound including at least one tertiary amine group of the type (3) is described for example in US2008/0113890.

The preparation of some suitable quaternary ammonium salt additives in which the compound including at least one tertiary amine group of the type (4) is described, for example in WO2016/016641.

Other suitable quaternary ammonium salts include quaternised terpolymers, for example as described in US2011/0258917; quaternised copolymers, for example as described in US2011/0315107; and the acid-free quaternised nitrogen compounds disclosed in US2012/0010112.

In some embodiments the present invention does not encompass acid-free quaternised nitrogen compounds. In preferred embodiments the quaternary ammonium salt additives of the invention include a separate anion and a separate cation.

In some embodiments the quaternary ammonium compounds for use in the present invention are the quaternised reaction product of a fatty acid (for example oleic acid) and dimethylaminopropyl amine.

Further suitable quaternary ammonium compounds for use in the present invention include the quaternary ammonium compounds described in the applicants copending applications WO2011/095819, WO2013/017889, WO2015/011506, WO2015/011507, WO2016/016641 and WO2017/017454.

Preferably additive (iii) comprises a quaternary ammonium salt which is the quaternised reaction product of a hydrocarbyl substituted succinic acid derived acylating agent and a compound able to react with said acylating agent and which includes a tertiary amine group.

Preferably the hydrocarbyl substituted acylated agent is a hydrocarbyl substituted succinic acid derived acylating agent.

For the avoidance of doubt, reference to the quaternised reaction product is meant to refer to a reaction product which comprises the tertiary amine which has then been quaternised to form a quaternary ammonium group. The quaternary ammonium salt additive is formed by reacting a quaternising agent with the reaction product of a hydrocarbyl substituted succinic acid derived acylating agent and a compound able to react with said acylating agent and which includes a tertiary amine group.

Suitable hydrocarbyl substituted succinic acid derived acylating agents and means of preparing them are well known in the art. For example a common method of preparing a hydrocarbyl substituted succinic acylating agent is by the reaction of maleic anhydride with an olefin using a chlorination route or a thermal route (the so-called “ene” reaction).

Illustrative of hydrocarbyl substituent based groups include n-octyl, n-decyl, n-dodecyl, tetrapropenyl, n-octadecyl, oleyl, chloroctadecyl, triicontanyl, etc. The hydrocarbyl based substituents may be made from homo- or interpolymers (e.g. copolymers, terpolymers) of mono- and di-olefins having 2 to 10 carbon atoms, for example ethylene, propylene, butane-1, isobutene, butadiene, isoprene, 1-hexene, 1-octene, etc. Preferably these olefins are 1-monoolefins. Alternatively the substituent may be made from other sources, for example monomeric high molecular weight alkenes (e.g. 1-tetra-contene), aliphatic petroleum fractions, for example paraffin waxes and cracked analogs thereof, white oils, synthetic alkenes for example produced by the Ziegler-Natta process (e.g. poly(ethylene) greases) and other sources known to those skilled in the art. Any unsaturation in the substituent may if desired be reduced or eliminated by hydrogenation according to procedures known in the art.

Preferably the hydrocarbyl substituents are predominantly saturated, that is, they contain no more than one carbon-to-carbon unsaturated bond for every ten carbon-to-carbon single bonds present. Most preferably they contain no more than one carbon-to-carbon non-aromatic unsaturated bond for every 50 carbon-to-carbon bonds present.

The hydrocarbyl substituent of the succinic acid derived acylating agent preferably comprises at least 10, more preferably at least 12, for example at least 30 or at least 40 carbon atoms. It may comprise up to about 200 carbon atoms. Preferably the hydrocarbyl substituent of the acylating agent has a number average molecular weight (Mn) of between 170 to 2800, for example from 250 to 1500, preferably from 500 to 1500 and more preferably 500 to 1100. An Mn of 700 to 1300 is especially preferred.

The skilled person would be familiar with standard techniques to measure number average molecular weight, such as by vapor pressure osmometry, end-group titration, proton NMR, boiling point elevation, freezing depression (cryoscopy), and GPC (gel permeation chromatography).

The hydrocarbyl substituted succinic acid derived acylating agent may comprise a mixture of compounds. For example a mixture of compounds having different hydrocarbyl substituents may be used.

Preferred hydrocarbyl-based substituents are polyisobutenes. Such compounds are known to the person skilled in the art.

Preferred hydrocarbyl substituted succinic acid derived acylating agents are polyisobutenyl succinic anhydrides. These compounds are commonly referred to as “PIBSAs” and are known to the person skilled in the art.

Conventional polyisobutenes and so-called “highly-reactive” polyisobutenes are suitable for use in the invention. Suitable highly reactive polyisobutenes are as defined above.

Other preferred hydrocarbyl groups include those having an internal olefin for example as described in the applicant's published application WO2007/015080.

An internal olefin as used herein means any olefin containing predominantly a non-alpha double bond, that is a beta or higher olefin. Preferably such materials are substantially completely beta or higher olefins, for example containing less than 10% by weight alpha olefin, more preferably less than 5% by weight or less than 2% by weight. Typical internal olefins include Neodene 15181O available from Shell.

Internal olefins are sometimes known as isomerised olefins and can be prepared from alpha olefins by a process of isomerisation known in the art, or are available from other sources. The fact that they are also known as internal olefins reflects that they do not necessarily have to be prepared by isomerisation.

Preferred hydrocarbyl substituted succinic acid derived acylating agents for use in preparing additive (iii) of the present invention are polyisobutenyl substituted succinic anhydrides or PIBSAs. Especially preferred PIBSAs are those having a PIB molecular weight (Mn) of from 300 to 2800, preferably from 450 to 2300, more preferably from 500 to 1300.

The hydrocarbyl substituted succinic acid derived acylating agent is suitably prepared by reacting maleic anhydride with an alkene, for example a polyisobutene. The product obtained (such as a PIBSA) still includes a double bond. The maleic anhydride is present in the resultant molecule as a succinic acid moiety. This initial product is a monomaleated PIBSA.

The monomaleated PIBSA may have the structure (A) or (B):

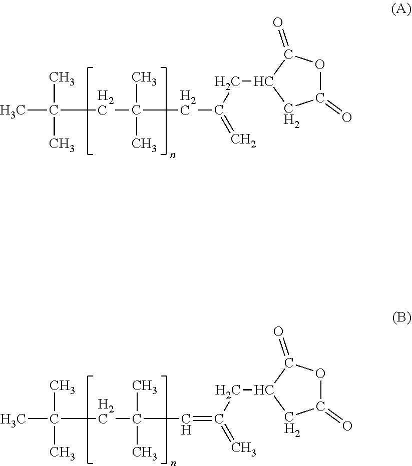

The double bond in the monomaleated product can react with a further molecule of maleic anhydride to form a bismaleated PIBSA having the structure (C) or (D):

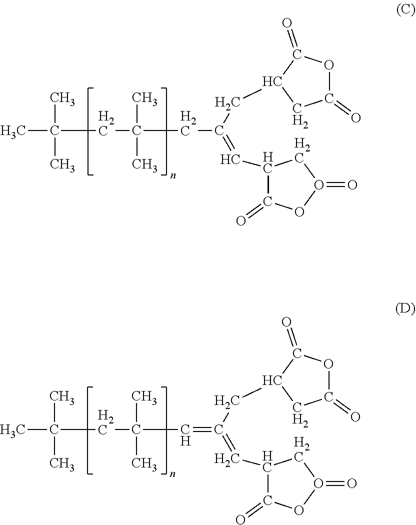

Thus it is possible to provide a hydrocarbyl group which is substituted with more than one succinic acid moiety.

The skilled person will appreciate that the additives used in the invention typically comprise mixtures of compounds and will be prepared from a mixture of monomaleated and bismaleated PIBSAs. The PIBSAs may be defined in terms of their level of bismaleation.

One way in which this may be determined is by calculating the average number of succinic acid moieties per molecule of acylating agent.

A monomaleated PIBSA has one succinic acid moiety per module.

A bismaleated PIBSA has two succinic acid moieties per molecule.

A mixture comprising monomaleated PIBSA and bismaleated PIBSA in a 1:1 molar ratio would comprise an average of 1.5 succinic acid moieties per molecule of PIBSA.

The average number of succinic acid moieties per molecule of acylating agent is sometimes referred to in the art as “P value”.

Suitably the quaternary ammonium salt additive is prepared from a hydrocarbyl substituted succinic acid derived acylating agent comprising on average from 1 to 2 succinic acid moieties per molecule.

In some preferred embodiments the present invention may involve the use of quaternary ammonium salts derived from hydrocarbyl substituted acylating agents which include an average of at least 1.2 succinic acid moieties per molecule.

As the skilled person will appreciate, a single molecule cannot have 1.2 succinic acid moieties. What is meant by at least 1.2 succinic acid moieties is the mean number of succinic acid moieties per molecule of acylating agent as the sum of all the succinic acid moieties present in a sample divided by the total number of molecules of acylating agent having one or more succinic acid moieties present in the sample.

Preferably the hydrocarbyl substituted succinic acid derived acylating agent comprises on average at least 1.21 succinic acid moieties per molecule, more preferably at least 1.22 succinic acid moieties per molecule.

In some embodiments the hydrocarbyl substituted succinic acid derived acylating agent may comprise at least 1.23 or at least 1.24 succinic acid moieties per molecule.

In some embodiments the hydrocarbyl substituted succinic acid derived acylating agent may comprise at least 1.25, at least 1.26 or at least 1.27 succinic acid moieties per molecule.

In some embodiments the hydrocarbyl substituted succinic acid derived acylating agent may comprise at least 1.28, at least 1.29 or at least 1.30 succinic acid moieties per molecule.

By succinic acid moiety we mean to include residues of succinic acid present in diacid or anhydride form.

The hydrocarbyl substituted succinic acid derived acylating agent is reacted with a compound able to react with said acylating agent and which includes a tertiary amine group. The tertiary amine group is quaternised to provide the quaternary ammonium salt additive.

Examples of suitable compounds able to react with the hydrocarbyl substituted succinic acid derived acylating agent and which include a tertiary amine group can include but are not limited to: N,N-dimethylaminopropylamine, N,N-diethylaminopropylamine, N,N-dimethylamino ethylamine. The nitrogen or oxygen containing compounds capable of condensing with the acylating agent and further having a tertiary amino group can further include amino alkyl substituted heterocyclic compounds such as 1-(3-aminopropyl)imidazole and 4-(3-aminopropyl)morpholine, 1-(2-aminoethyl)piperidine, 3,3-diamino-N-methyldipropylamine, and 3′3-aminobis(N,N-dimethylpropylamine). Other types of nitrogen or oxygen containing compounds capable of condensing with the acylating agent and having a tertiary amino group include alkanolamines including but not limited to triethanolamine, trimethanolamine, N,N-dimethylaminopropanol, N,N-dimethylaminoethanol, N,N-diethylaminopropanol, N,N-diethylaminoethanol, N,N-diethylaminobutanol, N,N,N-tris(hydroxyethyl)amine, N,N,N-tris(hydroxymethyl)amine, N,N,N-tris(aminoethyl)amine, N,N-dibutylaminopropylamine and N,N,N′-trimethyl-N′-hydroxyethyl-bisaminoethylether; N,N-bis(3-dimethylaminopropyl)-N-isopropanolamine; N-(3-dimethylaminopropyl)-N,N-diisopropanolamine; N′-(3-(dimethylamino)propyl)-N,N-dimethyl 1,3-propanediamine; 2-(2-dimethylaminoethoxy)ethanol, N,N,N′-trimethylaminoethylethanolamine and 3-(2-(dimethylamino)ethoxy) propylamine.

Preferably the compound able to react with hydrocarbyl substituted succinic acid derived acylating agent and which includes a tertiary amine group is an amine of formula (XII) or (XIII):

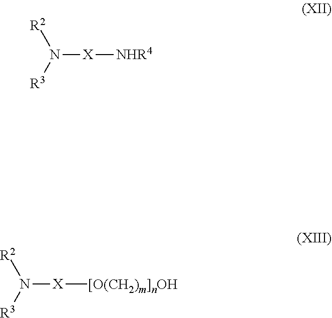

wherein R² and R³ are the same or different alkyl, alkenyl, aryl, alkaryl or aralkyl groups having from 1 to 22 carbon atoms; X is a bond or an optionally substituted alkylene group having from 1 to 20 carbon atoms; n is from 0 to 20; m is from 1 to 5; and R⁴ is hydrogen or a C₁ to C₂₂ alkyl group.

When a compound of formula (XII) is used, R⁴ is preferably hydrogen or a C₁ to C₁₆ alkyl group, preferably a C₁ to C₁₀ alkyl group, more preferably a C₁ to C₆ alkyl group. When R⁴ is alkyl it may be straight chained or branched. It may be substituted for example with a hydroxy or alkoxy substituent. Preferably R⁴ is not a substituted alkyl group. More preferably R⁴ is selected from hydrogen, methyl, ethyl, propyl, butyl and isomers thereof. Most preferably R⁴ is hydrogen.

When a compound of formula (XIII) is used, m is preferably 2 or 3, most preferably 2; n is preferably from 0 to 15, preferably 0 to 10, more preferably from 0 to 5. Most preferably n is 0 and the compound of formula (XIII) is an alcohol.

Preferably the hydrocarbyl substituted acylating agent is reacted with a diamine compound of formula (XII).

R² and R³ are the same or different alkyl, alkenyl, aryl, alkaryl or aralkyl groups having from 1 to 22 carbon atoms. In some embodiments R² and R³ may be joined together to form a ring structure, for example a piperidine, imidazole or morpholine moiety. Thus R² and R³ may together form an aromatic and/or heterocyclic moiety. R² and R³ may be branched alkyl or alkenyl groups. Each may be substituted, for example with a hydroxy or alkoxy substituent.

Preferably each of R² and R³ is independently a C₁ to C₁₆ alkyl group, preferably a C₁ to C₁₀ alkyl group. R² and R³ may independently be methyl, ethyl, propyl, butyl, pentyl, hexyl, heptyl, octyl, or an isomer of any of these. Preferably R² and R³ is each independently C₁ to C₄ alkyl. Preferably R² is methyl. Preferably R³ is methyl.

X is a bond or an optionally substituted alkylene group having from 1 to 20 carbon atoms. In preferred embodiments when X is an alkylene group this group may be straight chained or branched. The alkylene group may include a cyclic structure therein. It may be optionally substituted, for example with a hydroxy or alkoxy substituent. In some embodiments X may include a heteroatom within the alkylene chain, for example X may include an ether functionality.

X is preferably an alkylene group having 1 to 16 carbon atoms, preferably 1 to 12 carbon atoms, more preferably 1 to 8 carbon atoms, for example 2 to 6 carbon atoms or 2 to 5 carbon atoms. In some preferred embodiments X is an unsubstituted alkylene group. Most preferably X is an ethylene, propylene or butylene group, especially a propylene group.

Examples of compounds of formula (XII) suitable for use herein include 1-aminopiperidine, 1-(2-aminoethyl)piperidine, 1-(3-aminopropyl)-2-pipecoline, 1-methyl-(4-methylamino)piperidine, 4-(1-pyrrolidinyl)piperidine, 1-(2-aminoethyl)pyrrolidine, 2-(2-aminoethyl)-1-methylpyrrolidine, N,N-diethylethylenediamine, N,N-dimethylethylenediamine, N,N-dibutylethylenediamine, N,N-diethyl-1,3-diaminopropane, N,N-dimethyl-1,3-diaminopropane, N,N,N′-trimethylethylenediamine, N,N-dimethyl-N′-ethylethylenediamine, N,N-diethyl-N′-methylethylenediamine, N,N,N′-triethylethylenediamine, 3-dimethylaminopropylamine, 3-diethylaminopropylamine, 3-dibutylaminopropylamine, N,N,N′-trimethyl-1,3-propanediamine, N,N,2,2-tetramethyl-1,3-propanediamine, 2-amino-5-diethylaminopentane, N,N,N′,N′-tetraethyldiethylenetriamine, 3,3′-diamino-N-methyldipropylamine, 3,3′-iminobis(N,N-dimethylpropylamine), 1-(3-aminopropyl)imidazole and 4-(3-aminopropyl)morpholine, 1-(2-aminoethyl)piperidine, 3,3-diamino-N-methyldipropylamine, 3,3-aminobis(N,N-dimethylpropylamine), 3-(2-(dimethylamino)ethoxy) propylamine, or combinations thereof.

In some preferred embodiments the compound of formula (XII) is selected from N,N-dimethyl-1,3-diaminopropane, N,N-diethyl-1,3-diaminopropane, N,N-dimethylethylenediamine, N,N-diethylethylenediamine, N,N-dibutylethylenediamine, 3-(2-(dimethylamino)ethoxy) propylamine, or combinations thereof.

Examples of compounds of formula (XIII) suitable for use herein include alkanolamines including but not limited to triethanolamine, N,N-dimethylaminopropanol, N,N-diethylaminopropanol, N,N-diethylaminobutanol, triisopropanolamine, 1-[2-hydroxyethyl]piperidine, 2-[2-(dimethylamine)ethoxy]-ethanol, N-ethyldiethanolamine, N-methyldiethanolamine, N-butyldiethanolamine, N,N-diethylaminoethanol, N,N-dimethyl amino-ethanol, 2-dimethylamino-2-methyl-1-propanol, N,N,N′-trimethyl-N′-hydroxyethyl-bisaminoethylether; N,N-bis(3-dimethylaminopropyl)-N-isopropanolamine; N-(3-dimethylaminopropyl)-N,N-diisopropanolamine; N′-(3-(dimethylamino)propyl)-N,N-dimethyl 1,3-propanediamine; 2-(2-dimethylaminoethoxy)ethanol, and N,N,N′-trimethylaminoethylethanolamine.

In some preferred embodiments the compound of formula (XIII) is selected from Triisopropanolamine, 1-[2-hydroxyethyl]piperidine, 2-[2-(dimethylamine)ethoxy]-ethanol, N-ethyldiethanolamine, N-methyldiethanolamine, N-butyldiethanolamine, N,N-diethylaminoethanol, N,N-dimethylaminoethanol, 2-dimethylamino-2-methyl-1-propanol, or combinations thereof.

An especially preferred compound of formula (XII) is N,N-dimethyl-1,3-diaminopropane (dimethylaminopropylamine).

When a compound of formula (XIII) is reacted with a succinic acylating agent the resulting product is a succinic ester. When a succinic acylating agent is reacted with a compound of formula (XII) in which R⁴ is hydrogen the resulting product may be a succinimide or a succinamide. When a succinic acylating agent is reacted with a compound of formula (XII) in which R⁴ is not hydrogen the resulting product is an amide.

To form the quaternary ammonium salt additive (iii), the hydrocarbyl substituted succinic acid derived acylating agent is reacted with a compound able to react with said acylating agent and which includes a tertiary amine group. This reaction product is then quaternised by reaction with a quaternising agent.

The reaction product of the acylating agent and compound which includes a tertiary amine group is preferably reacted with at least one molar equivalent of quaternising agent per mole of tertiary amine group present in the reaction product.

In some embodiments the reaction product of the acylating agent and compound which includes a tertiary amine group may be reacted with more than one molar equivalent of quaternising agent per mole of tertiary amine group present in the reaction product, preferably at least 1.2 molar equivalents of quaternising agent per mole of tertiary amine group, more preferably at least 1.5 molar equivalents of quaternising agent, suitably at least 1.7 molar equivalents of quaternising agent, for example at least 1.9 molar equivalents of quaternising agent.

In some embodiments the reaction product of the acylating agent and compound which includes a tertiary amine group may be reacted with two or more molar equivalents of quaternising agent per mole of tertiary amine group present in the reaction product, preferably at least 2.1 molar equivalents of quaternising agent.

In some embodiments the reaction product of the acylating agent and compound which includes a tertiary amine group is reacted with more than 2.2 molar equivalents of quaternising agent per mole of tertiary amine group present in the reaction product, for example from 2.3 to 4 molar equivalents, from 2.3 to 3 molar equivalents, or from 2.3 to 2.7 or from 2.5 to 3 molar equivalents.

To form some preferred quaternary ammonium salt additives of the present invention the compound of formula (XI) is reacted with a compound formed by the reaction of a hydrocarbyl substituted acylating agent and an amine of formula (XII) or (XIII).

The compounds of formula (XII) or formula (XIII) are as described above.

Preferably the amine of formula (XII) or (XIII) is reacted with a hydrocarbyl substituted succinic acid derived acylating agent such as a succinic acid or succinic anhydride.

Suitably approximately one equivalent of amine is added per succinic acid moiety present in the acylating agent. The ratio of amine used will thus typically depend on the average number of succinic acid moieties present in each molecule of the acylating agent.

Preferred quaternary ammonium salts for use herein may be formed by reacting methyl salicylate, dimethyl oxalate or propylene oxide optionally in combination with an acid with the reaction product of a polyisobutylene-substituted succinic anhydride having a PIB molecular weight (Mn) of 700 to 1300 and dimethylaminopropylamine. A mixture of two or more such quaternary ammonium salts may be used.

A preferred quaternary ammonium salt for use herein is a quaternary ammonium salt of the reaction product of a polyisobutylene-substituted succinic anhydride having a PIB molecular weight (Mn) of 700 to 1300 and dimethylaminopropylamine.

An especially preferred quaternary ammonium salt for use herein is formed by reacting methyl salicylate or dimethyl oxalate with the reaction product of a polyisobutylene-substituted succinic anhydride having a PIB molecular weight (Mn) of 700 to 1300 and dimethylaminopropylamine.

In one preferred embodiment the polyisobutylene-substituted succinic anhydride includes on average at least 1.2 succinic acid moieties per molecule.

The antioxidant, when present, is preferably included in the composition of the first aspect in an amount of at least 10 ppm, preferably at least 20 ppm, more preferably at least 50 ppm, for example at least 70 ppm.

The antioxidant, when present, may be included in the composition of the first aspect in an amount of up to 10000 ppm, preferably up to 5000 ppm, more preferably up to 2000 ppm, for example up to 1000 ppm.

The stabilising additive, when present, is preferably included in the composition of the first aspect in an amount of at least 10 ppm, preferably at least 20 ppm, more preferably at least 50 ppm, for example at least 70 ppm.

The stabilising additive, when present, may be included in the composition of the first aspect in an amount of up to 10000 ppm, preferably up to 5000 ppm, more preferably up to 2000 ppm, for example up to 1000 ppm.

Alkoxylated amine compounds, when present, are preferably included in the composition of the first aspect in an amount of at least 5 ppm, preferably at least 10 ppm, more preferably at least 20 ppm, for example at least 40 ppm.

Alkoxylated amine compounds, when present, may be included in the composition of the first aspect in an amount of up to 7000 ppm, preferably up to 3000 ppm, more preferably up to 1500 ppm, for example up to 800 ppm.

Aldehyde-alkylphenol copolymers, when present, are preferably included in the composition of the first aspect in an amount of at least 5 ppm, preferably at least 10 ppm, more preferably at least 20 ppm, for example at least 30 ppm.

Aldehyde-alkylphenol copolymers, when present, may be included in the composition of the first aspect in an amount of up to 5000 ppm, preferably up to 3000 ppm, more preferably up to 1000 ppm, for example up to 700 ppm.

In this specification any reference to ppm is to parts per million by weight.

In preferred embodiments the stabilising additive (b) comprises 1 part (by weight) of alkoxylated amine compounds (i) and 0.5 to 2.5 parts (by weight) of aldehyde-alkylphenol copolymers.

The stabilising additive may also comprise a carrier or diluent. Preferred carriers and diluents are aromatic hydrocarbon compounds, especially C₁₀ alkyl naphthalene.

In a preferred embodiment, the composition of the first aspect comprises from 100 to 1000 ppm, preferably 250 to 750 ppm of an antioxidant and/or from 100 to 1000 ppm, preferably 250 to 750 ppm of a stabilising additive selected from (i) alkoxylated amine compounds; (ii) aldehyde-alkylphenol copolymers; and mixtures thereof.

In a preferred embodiment, the composition of the first aspect comprises from 100 to 1000 ppm, preferably 250 to 750 ppm of an antioxidant and/or from 0 to 500 ppm, preferably 100 to 300 ppm of alkoxylated amine compounds and/or from 0 to 500 ppm, preferably 100 to 300 ppm aldehyde-alkylphenol copolymers.

In a preferred embodiment, the composition of the first aspect comprises from 50 to 500 ppm, preferably 125 to 325 ppm of one or more quaternary ammonium salts, suitably wherein the quaternary ammonium salt is a polyisobutenyl substituted succinimide ammonium salt, for example a quaternary ammonium salt of the reaction product of a polyisobutylene-substituted succinic anhydride having a PIB molecular weight (Mn) of 700 to 1300 and dimethylaminopropylamine.

In a preferred embodiment, the composition of the first aspect comprises from 200 to 400 ppm, preferably 275 to 375 ppm of a polyisobutenyl substituted succinimide, for example the reaction product of a polyisobutene-substituted succinic acid or succinic anhydride and a polyethylene polyamine, suitably selected from ethylenediamine, diethylenetriamine, triethylenetetramine, tetraethylenepentamine, pentaethylenehexamine, hexaethylene-heptamine and mixtures and isomers thereof; suitably tetraethylenepentamine; suitably wherein polyisobutene substituent has a number average molecular weight of between 500 and 2000, preferably between 600 and 1000.

In some embodiments the composition of the first aspect may be used as a middle distillate fuel oil. Thus the composition may include one or more further additives such as those which are commonly found in diesel fuels. These include, for example, antioxidants, dispersants, detergents, metal deactivating compounds, wax anti-settling agents, cold flow improvers, cetane improvers, dehazers, stabilisers, demulsifiers, antifoams, corrosion inhibitors, lubricity improvers, dyes, markers, combustion improvers, metal deactivators, odour masks, drag reducers and conductivity improvers. Examples of suitable amounts of each of these types of additives will be known to the person skilled in the art.

The inclusion of (a) an antioxidant; and/or (b) a stabilising additive selected from (i) alkoxylated amine compounds, (ii) aldehyde-alkylphenol copolymers, or mixtures thereof has surprisingly been found to improve the storage stability of compositions comprising pyrolysis oils.

According to a second aspect of the present invention there is provided a method of improving the stability of a composition comprising a pyrolysis oil, the method comprising adding to the composition one or more additives selected from:
(a) an antioxidant; and
(b) a stabilising additive selected from (i) alkoxylated amine compounds; (ii) aldehyde-alkylphenol copolymers; and mixtures thereof.

According to a further aspect of the present invention there is provided a method of improving the stability of a composition comprising a pyrolysis oil, the method comprising adding to the composition one or more additives selected from:
(a) an antioxidant; and
(b) a stabilising additive selected from (i) alkoxylated amine compounds; (ii) aldehyde-alkylphenol copolymers; (iii) quaternary ammonium salts; and mixtures thereof.

According to a third aspect of the present invention there is provided the use of one or more additives selected from:
(a) an antioxidant; and
(b) a stabilising additive selected from (i) alkoxylated amine compounds; (ii) aldehyde-alkylphenol copolymers; and mixtures thereof;
to improve the stability of a composition comprising a pyrolysis oil.

According to a further aspect of the present invention there is provided the use of one or more additives selected from:
(a) an antioxidant; and
(b) a stabilising additive selected from (i) alkoxylated amine compounds; (ii) aldehyde-alkylphenol copolymers; (iii) quaternary ammonium salts; and mixtures thereof;
to improve the stability of a composition comprising a pyrolysis oil.

Preferred features of the second and third aspects are as defined in relation to the first aspect. Further preferred features of the invention will now be described.

The one or more additives may be added to the composition comprising the pyrolysis oil at any time. It is preferred that they are added as soon as possible after synthesis of the oil, preferably before the oil cools.

The method and use of the present invention improve the stability of a composition comprising a pyrolysis oil.

Preferably the method and use improve the stability of a composition comprising a plastic pyrolysis oil.

Preferably the method and use improve the storage stability of compositions comprising a pyrolysis oil.

Preferably the method and use improve the storage stability of composition comprising a plastic pyrolysis oil.

An improvement in storage stability suitably results in a reduction in degradation of the oil on storage. This may be observed in a number of ways.

In some embodiments the improvement in stability may provide reduced discolouration on storage.

In some embodiments the improvement in stability may provide reduced sedimentation.

In some embodiments the improvement in stability may reduce or prevent increases in viscosity.

In some embodiments the improvement in stability may reduce the formation of gums and particulates in the composition comprising the pyrolysis oil.

In some embodiments the improvement in stability may provide improved filterability, particularly after storage.

In some embodiments the improvement in stability may provide an improvement in low temperature properties of the composition comprising the pyrolysis oil.

One way in which the improvement in stability is measured is described in example 1. In this example precipitation from a pyrolysis oil over time is collected by filtration. Residues which adhere to the surfaces of the storage vessel are also examined.

Preferably the method and use of the present invention reduce the formation of insoluble residues in a pyrolysis oil by at least 5 wt %, preferably at least 10 wt %, for example at least 15 wt %.

The invention will now be further described with reference to the following non-limiting examples.

### Example 1

500 mg/L of the following additive was added to a commercially sourced plastic pyrolysis oil:

| Dispersant 1 | |
|---|---|
| Ethoxylated and propoxylated ethylenediamine | 25.2 wt % |
| (CAS: 26316-40-5) | |
| Formaldehyde polymer with nonylphenol (CAS: | 50.7 wt % |
| 9040-65-7; 40-60% active in aromatic solvent) | |
| Aliphatic kerosene type solvent | 24.1 wt % |

The storage stability of the additised oil was compared with that of unadditised oil. During the storage period of 28 days the compositions were kept at a minimum temperature of 15° C.

The testing involved agitating the cans to ensure any sediment was dispersed, extracting 500 ml from each can and filtering through a Nitrocellulose filter (0.8 μm). This filter was subsequently dried with 2,2,4-trimethylpentane—which is known to wash away any residual pyrolysis oil without dissolving deposits. The weight of the filter was measured before and after to quantify the amount present.

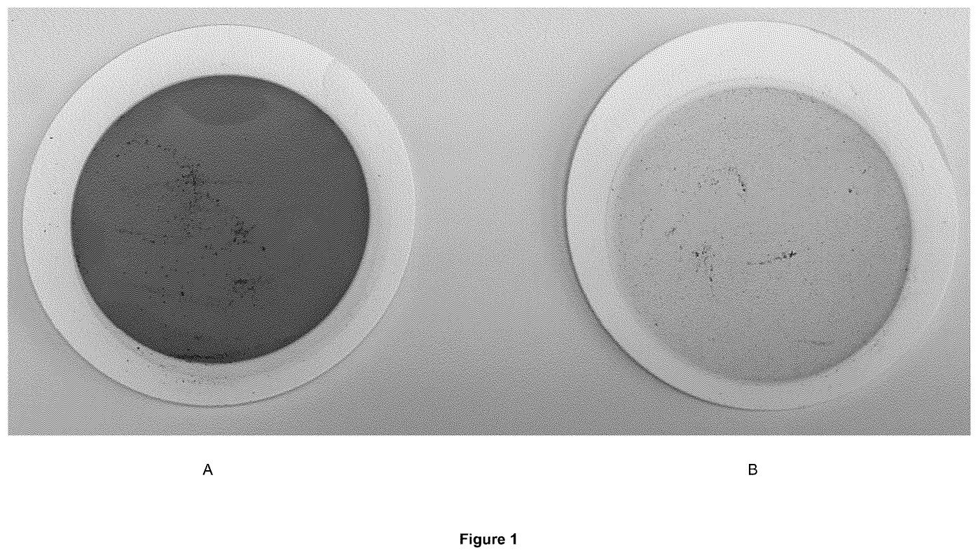

The results are shown in table 1 and the filter papers shown in FIG. 1:

TABLE 1

| | Weight of | Weight of | | Total |
|---|---|---|---|---|
| | Filter Paper | Filter Paper | Weight of | Residue |
| Composition | (Before) | (After) | residue | mg/L |
| A - unadditised | 69.8 mg | 77.9 mg | 8.1 mg | 16.2 |
| pyrolysis oil | | | | |
| B - pyrolysis oil | 70.3 mg | 77.1 mg | 6.8 mg | 13.6 |
| additised with 500 | | | | |
| mg/l dispersant 1 | | | | |

### Example 2

Compositions were prepared by dosing the following additives into a plastic pyrolysis oil:

TABLE 2

| Composition | Additive | Treat rate (mg/L) |
|---|---|---|
| C | Dispersant 1 | 250 |
| D | Dispersant 1 | 500 |
| E | Antioxidant 1 | 250 |
| F | Antioxidant 1 | 500 |

Dispersant 1 is as defined in example 1.

Antioxidant 1 is a phenolic antioxidant comprising at least 75 wt % 2,6-ditertiary-butyl-phenol and up to 25 wt % tertiary and tritertiary-butyl-phenols.

After a storage period of four weeks, 500 ml of each fuel was filtered through a nitrocellulose filter (0.8 μm).

This filter was subsequently washed with 2,2,4-trimethylpentane, which is known to wash away any residual pyrolysis oil without dissolving deposits, and then dried.

The weight of the filter papers was measured before and after to quantify the amount of insoluble material present.

Following the filtration, the adherent insolubles that remained in the storage bottle were then dissolved in the trisolvent (1:1:1-acetone:toluene:methanol) and transferred into pre-weighed beakers.

The solvent was then evaporated and the content of adherent insolubles was determined.

The total amount of insoluble material recovered for each composition is shown in table 3:

TABLE 3

| Composition | Total Insoluble (mg/kg) |
|---|---|
| Unadditised plastic pyrolysis oil | 1381.87 |
| C | 727.59 |
| D | 836.84 |
| E | 650.80 |
| F | 683.20 |

### Example 3

Further example compositions were prepared by dosing the following additives into a plastic pyrolysis oil:

TABLE 4

| Composition | Additive | Treat rate (mg/L) |
|---|---|---|
| G | Additive 2 | 250 |
| H | Additive 2 | 500 |
| I | Additive 3 | 500 |

Additive 2 is a polyisobutenyl substituted succinimide ammonium salt and was prepared as follows:

A polyisobutenyl succinic anhydride (PIBSA) was prepared by charging 700 g (0.7 mol) of polyisobutylene (Mn 1000) to a nitrogen flushed, jacketed reactor fitted with an overhead stirrer. The starting material was heated to 120° C. with stirring and nitrogen flushing was repeated. The reaction temperature was increased to 190° C. and maleic anhydride (82.4 g, 0.84 mol, 1.2 eq) was charged over 1 hour. After maintaining a temperature of 190° C. for a further 1 hour, the temperature was increased to 200-208° C. and held in this range for 8 hours. Vacuum (<30 mbar) was then applied for 2.5 hrs, whilst maintaining the reaction temperature, which reduced the level of residual maleic anhydride to <0.05 wt %. The reaction mass was cooled to <80° C. then discharged from the reactor.

The PIBSA prepared as described above was charged to a nitrogen flushed, jacketed reactor fitted with an overhead stirrer and heated to 120° C. 3-(dimethylamino)propylamine (DMAPA) (1 eq relative to anhydride groups) was charged slowly, maintaining the reaction temperature between 120-130° C. After stirring at 120° C. for a further 1 hr, the reaction temperature was increased to 140° C. and held for 3 hrs with concurrent distillation of water. Methyl salicylate (2.1 eq relative to anhydride groups) was added in a single portion and heating was continued at 140° C. for 10 hours. The reaction mass was diluted with Aromatic 150 solvent to provide an overall solids content of 60 wt % prior to discharging from the reactor.

Additive 3 is a polyisobutenyl substituted succinimide and was prepared as follows:

Using the reaction set up of a 1 L jacketed glass reactor, fitted with a Dean Stark condenser, overhead stirrer, dropping funnel and nitrogen input. To the reactor was transferred 600 g of PIBSA (HR 750 mw PIB, 0.768 moles) and 483.33 g of Aromatic A150 solvent. The mixture was stirred and heated to 65° C. to form a homogenous liquid. Then tetraethylenepentamine (138.12 g, 0.729 mol) was charged to the reactor over 1 hour via the dropping funnel. The temperature of the mixture was increased to 135° C. and held for 1 hour allowing distillation of water. The temperature of the mixture was then increased to 165° C. and held for 3 hours. After distillation was complete the product was cooled and transferred to storage (1208.32 g).

The storage stability of the pyrolysis oil compositions G, H and I was tested as described above for Example 2. The amounts of insoluble material recovered (filterable and adherent) for each composition, including the total amounts, are shown in Table 5:

TABLE 5

| | Filterable | Adherent | Total |
|---|---|---|---|
| | insoluble | Insoluble | Insoluble |
| Composition | (mg/kg) | (mg/kg) | (mg/kg) |
| Unadditised plastic | 5.75 | 475.12 | 480.87 |
| pyrolysis oil | | | |
| G | 38.22 | 455.15 | 493.37 |
| H | 98.30 | 280.87 | 379.17 |
| I | 109.14 | 269.18 | 378.32 |

These results show a significant reduction in the amount of adherent insoluble material produced by the plastic pyrolysis oil on storage when the additives of the present invention are used. Also, the results for compositions H and I show that the additives 2 and 3 (at 500 mg/I treat rate) also significantly reduce the total amount of insoluble material produced. These additives may therefore be effective in improving the stability of a composition comprising a pyrolysis oil.

1. A composition comprising a pyrolysis oil and, as an additive, one or more of:
(a) an antioxidant; and
(b) a stabilising additive selected from (i) alkoxylated amine compounds; (ii) aldehyde-alkylphenol copolymers; (iii) a quaternary ammonium salt, and mixtures thereof.

2. A method of improving the stability of a composition comprising a pyrolysis oil, the method comprising adding to the composition one or more additives selected from:
(a) an antioxidant; and
(b) a stabilising additive from (i) alkoxylated amine compounds; (ii) aldehyde-alkylphenol copolymers; (iii) a quaternary ammonium salt, and mixtures thereof.

3. (canceled)

4. The composition of claim 1, wherein the pyrolysis oil is a plastic pyrolysis oil.

5. The composition of claim 1, further comprising an antioxidant.

6. The composition of claim 5, wherein the antioxidant is a phenolic antioxidant.

7. The composition of claim 6, wherein the phenolic antioxidant is selected from tertiarybutylhydroquinone (TBHQ or MTBHQ), 2,5-di-tertiarybutylhydroquinone (DTBHQ), pyrogallol, pyrocatechol 2,6-di-tert-butyl-4-methylphenol (BHT), 2,6-ditertiary-butyl-phenol, propylgallate and tertiarybutylcatechol.

8. The composition of claim 5, wherein the antioxidant is a polyisobutenyl substituted succinimide.

9. The composition of claim 1, wherein the antioxidant comprises an amino based antioxidant.

10. (canceled)

11. The composition of claim 1, wherein the stabilising additive comprises alkoxylated amine compounds.

12. The composition of claim 11 wherein the alkoxylated amine compounds comprise compounds of formula (II): 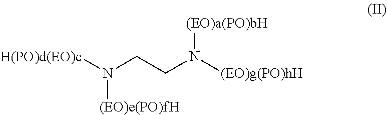
wherein EO represents an ethylene oxide residue, PO represents a propylene oxide residue and at least one of a, b, c, d, e, f, g and h is not 0.

13. The composition of claim 10 wherein the stabilising additive comprises aldehyde-alkylphenol copolymers.

14. The composition of claim 13 wherein the aldehyde-alkylphenol copolymers have the structures (III) or (IV): 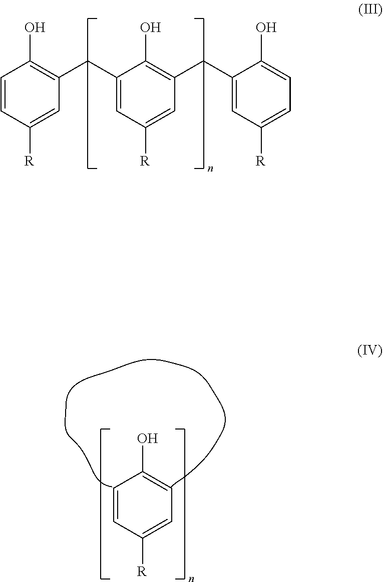
wherein R is hydrogen or an alkyl group and n is at least 1.

15. The composition of claim 1, wherein the stabilising additive comprises (iii) a quaternary ammonium salt.

16. The composition of claim 15, wherein the quaternary ammonium salt is formed by reacting methyl salicylate or dimethyl oxalate with the reaction product of a polyisobutylene-substituted succinic anhydride having a PIB molecular weight (Mn) of 700 to 1300 and dimethylaminopropylamine.

17. The method of claim 2, wherein the improvement in stability is an improvement in storage stability.

18. The method of claim 2 that provides one or more of:
a reduction in discolouration on storage;
reduced sedimentation;
a reduction in the formation of gums and particulates;
improved filterability; and
an improvement in low temperature properties.
